(19) United States
(12) Patent Application Publication
(10) Pub. No.: US 2017/0081050 A1
(43) Pub. Date: Mar. 23, 2017

(54) GYROSCOPIC ACTUATOR WITH DOUBLE GIMBAL GUIDANCE, SUSPENSION ELEMENT AND END-STOP ELEMENT

(71) Applicants: THALES, COURBEVOIE (FR); CENTRE NATIONAL D'ETUDES SPATIALES, PARIS (FR)

(72) Inventors: Gilles GANS, CANNES LA BOCCA (FR); Xavier JEANDOT, CANNES LA BOCCA (FR); Gilles CARTE, CANNES LA BOCCA (FR)

(21) Appl. No.: 15/267,737

(22) Filed: Sep. 16, 2016

(30) Foreign Application Priority Data
Sep. 18, 2015 (FR) 1501932

(51) Int. Cl. B64G 1/28; G01C 19/32; G01C 19/26; B64G 1/10; G01C 19/16

(52) U.S. Cl. CPC B64G 1/286; B64G 1/10; G01C 19/16; G01C 19/26; G01C 19/32

(57) ABSTRACT

A dual guidance gyroscopic actuator comprises, a main structure connected to a platform, connected to a satellite, a ring, a U-shaped cradle, having first and second ends and a central part, a flywheel mounted on the central part between the first and second ends, being rotationally mobile with respect to the cradle about a first axis. A first bearing is positioned at the first end and a second bearing is positioned at the second end connecting the ring to the cradle, the first and second bearings rendering the cradle rotationally mobile with respect to the ring about a second axis substantially perpendicular to the first axis. The ring is connected to the main structure. The gyroscopic actuator comprises at least one suspension element limiting microvibrations from the cradle and flywheel and at least one end-stop element limiting travel cradle and of the flywheel with respect to the main structure.

### CROSS-REFERENCE TO RELATED APPLICATION

This application claims priority to foreign French patent application No. FR 1501932, filed on Sep. 18, 2015, the disclosure of which is incorporated by reference in its entirety.

### FIELD OF THE INVENTION

The invention relates to a dual guidance gyroscopic actuator with suspension and end-stop elements. The invention may be applied to the field of space in order to control and alter the orientation of spacecraft such as, for example, satellites.

### BACKGROUND

A gyroscopic actuator, also known by the abbreviation CMG which stands for Control Momentum Gyroscope, has the key function of generating a gyroscopic torque by combining two movements. The constant-speed rotation of a flywheel about the axis of rotation of the wheel creates a kinetic moment. A velocity is then imposed on the kinetic moment in the axis perpendicular to the axis of rotation of the flywheel. This axis is known as the gimbal axis and is the axis of rotation that causes the flywheel to rotate on its transverse axis. This results in a gyroscopic torque of the order of a few tens of Newton metres which is transmitted to the platform of the satellite. In other words, a gyroscopic actuator generates a gyroscopic torque through the combination of a kinetic moment created by the rotation of a flywheel spinning at constant speed and the rotational velocity of a gimbal axis perpendicular to the axis of rotation of the flywheel. One major disadvantage is that these two rotations each generate microvibrations which are then transmitted to the platform and disturb the stability of the line of sight of the satellite's observation instrument.

This principle of operation is depicted schematically in FIG. 1. The key function of the gyroscopic actuator is performed by the combination of the kinetic moment H of a flywheel and of the rotational velocity of a gimbal. The gyroscopic torque that results is the vector product of H and the rotational velocity of the gimbal.

In the prior art, there are various types of gyroscopic actuator for controlling the attitude of a spacecraft such as a satellite. One disadvantage with the actuators of the prior art stems from the fact that the flywheel is offset from the motorization and guidance part of the gimbal. As a result, the guidance part and notably the rolling bearing absorbs all of the bending stresses during the phase of launch of the satellite on which the actuator is mounted. Because the flywheel is not stacked, a certain preload is applied to this rolling bearing in order to take account of these heavy loadings during the launch phase. However, this preload has the effect of reducing the life of the rolling bearing and therefore of the actuator.

Another disadvantage with known gyroscopic actuators of the prior art lies in their bulkiness which prevents them from occupying a small volume.

An additional disadvantage of the gyroscopic actuators known from the prior art stems from the fact that microvibrations due to the high-speed rotation of the flywheel and to the rotation of the gimbal are generated. These microvibrations may spread into the platform of the satellite and disrupt the equipment, such as image-taking instruments for example.

The invention seeks to alleviate all or some of the problems mentioned hereinabove by proposing a compact gyroscopic actuator that has a special architecture with a gimbal guided by two guidance systems one on each side of a flywheel and the installation of suspension and end-stop elements to filter, at source, the microvibrations generated by the rotation of the flywheel and the rotation of the gimbal.

### SUMMARY OF THE INVENTION

To this end, one subject of the invention is a dual guidance gyroscopic actuator intended to be fitted to a satellite, comprising:

a main structure connected to a platform of the satellite,

a ring,

a cradle having a first end and a second end,

a flywheel mounted on the cradle between the first and second ends, the flywheel being rotationally mobile with respect to the cradle about a first axis of rotation,

characterized in that it comprises a first bearing positioned at the first end of the cradle and a second bearing positioned at the second end of the cradle connecting the ring to the cradle, the first and second bearings being configured to render the cradle rotationally mobile with respect to the ring about a second axis of rotation substantially perpendicular to the first axis of rotation, and in that the ring is connected to the main structure.

Advantageously, the gyroscopic actuator according to the invention comprises at least one suspension element able to limit microvibrations emanating from the cradle and from the flywheel.

Advantageously, the gyroscopic actuator according to the invention further comprises at least one end-stop element able to limit a travel of the cradle and of the flywheel with respect to the main structure.

According to one embodiment, the gyroscopic actuator according to the invention may comprise a motorization in the first end of the cradle, which motorization is intended to drive the cradle in rotation about the second axis of rotation.

According to another embodiment, the gyroscopic actuator according to the invention may comprise a power- and signal-transfer element in the second end of the cradle, which element is intended to transfer power and signals between the flywheel and the platform.

Advantageously, with the cradle and the flywheel forming a subassembly having a centre of gravity, the subassembly is configured to have its centre of gravity on the second axis of rotation.

Advantageously, with the ring, the cradle and the flywheel forming a suspended assembly, the flywheel and the cradle constituting two components of a first unit, the suspended assembly and the main structure constituting two components of a second unit, the gyroscopic actuator and the platform constituting two components of a third unit, the at least one suspension element is positioned between the two components of a unit.

Advantageously, the at least one end-stop element is positioned between the two components of a unit.

Advantageously, with the ring, the cradle and the flywheel forming a suspended assembly having a centre of gravity, the at least one suspension element having a barycentre, the at least one suspension element is configured in such a way that the barycentre of the at least one suspension element coincides substantially with the centre of gravity of the suspended assembly.

Advantageously, with the at least one end-stop element having a barycentre, the at least one end-stop element is configured in such a way that the barycentre of the at least one end-stop element coincides substantially with the centre of gravity of the suspended assembly.

The invention also relates to a satellite comprising at least three dual guidance gyroscopic actuators as described in this application and configured to manage the orientation of the satellite.

### BRIEF DESCRIPTION OF THE DRAWINGS

The invention will be better understood and further advantages will become apparent from reading the detailed description of one embodiment given by way of example, which description is illustrated by the attached drawing in which:

FIG. 1, already commented upon, illustrates the principle of operation of a gyroscopic actuator,

FIG. 2 depicts the architecture of a dual guidance gyroscopic actuator according to the invention,

FIG. 3 depicts the gimbal subassembly of the dual guidance gyroscopic actuator according to the invention,

FIG. 4 depicts the suspended assembly of the dual guidance gyroscopic actuator according to the invention,

FIG. 5 depicts one example of a configuration of the suspension modules and of the end-stop modules of the dual guidance gyroscopic actuator according to the invention,

FIG. 6 depicts another example of a configuration of the suspension elements and of the end-stop elements of the dual guidance gyroscopic actuator according to the invention,

FIG. 7 depicts one embodiment of the key structure of the dual guidance gyroscopic actuator according to the invention,

FIG. 8 schematically depicts a satellite comprising at least three gyroscopic actuators according to the invention.

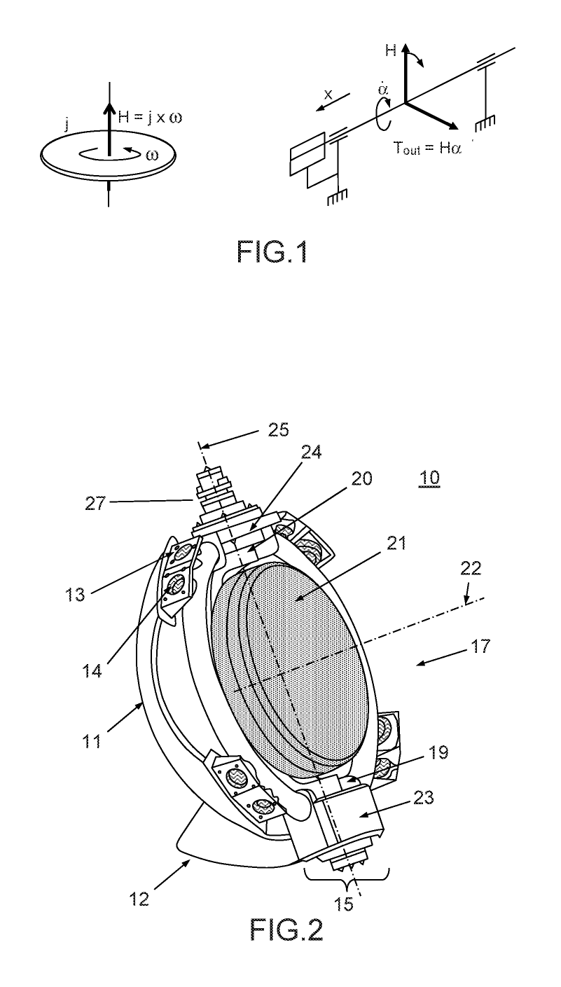

For the sake of clarity, in the various figures the same elements will bear the same references.

### DETAILED DESCRIPTION

The dual guidance gyroscopic actuator is intended for the positioning of agile satellites. The invention relies on two key points. First of all, the gyroscopic actuator has a specific architecture with a gimbal guided by two bearings, or guide elements, on each side of a flywheel. Moreover, suspension and end-stop elements are installed to filter out the microvibrations generated at source by the rotation of the flywheel and the rotation of the gimbal subassembly made up of the cradle and the flywheel. Specifically, a gyroscopic actuator generates a gyroscopic torque by the combination of a kinetic moment created by the rotation of a flywheel rotating at constant speed and the rotational velocity of a gimbal axis perpendicular to the axis of rotation of the flywheel. These two rotations each generate microvibrations which are then transmitted to the platform of the satellite and disturb the stability of the line of sight of the observation instrument.

During phases of manoeuvring and image capture by the scientific instruments onboard the satellite, the gyroscopic actuators rotate the gimbal axis, the flywheel spinning at constant speed, to generate a gyroscopic torque. According to the invention, the microvibrations generated by these two movements are attenuated by the installation of a number of suspension elements in order to reduce as far as possible the transmission of the disturbances to the platform. Because the mobile assembly is suspended by the suspension elements and not stacked during the launch, it is necessary to install end-stop elements in order to limit the dynamic travel of the mobile mass, which means to say of the suspended assembly made up of the gimbal subassembly and of the ring, during the launch and to transmit the launch loadings to the main structure with associated attenuation via these end-stop elements.

FIG. 2 depicts the architecture of a dual guidance gyroscopic actuator 10 according to the invention. The dual guidance gyroscopic actuator 10 is intended to be fitted to a satellite. It comprises a main structure 11 connected to a platform 12 of the satellite, a ring 16, a cradle 18 having a first end 19 and a second end 20 and a flywheel 21 mounted on the cradle 18 between the first and the second ends 19, 20, the flywheel 21 being rotationally mobile with respect to the cradle 18 about a first axis of rotation 22. The cradle 18 is U-shaped. What is meant by U-shaped is any shape that can be likened to a U, namely any shape that has a central part extending in one direction and ending in two ends extending in another direction substantially perpendicular to the direction of the central part. In the extreme, the cradle 18 may also be substantially semicircular in shape. The cradle 18 is configured to allow the rotation of the flywheel 21 positioned on the central part between its two ends. For example, the flywheel 21 may be mounted in a casing and the casing may be mounted on the cradle 18, with no relative motion between the casing and the cradle 18. Still other alternative configurations are conceivable, depending on the shape of the cradle 18. According to the invention, the gyroscopic actuator 10 comprises a first bearing 23 positioned at the first end 19 of the cradle 18 and a second bearing 24 positioned at the second end 20 of the cradle 18 connecting the ring 16 to the cradle 18, the first and second bearings 23, 24 being configured to render the cradle 18 rotationally mobile with respect to the ring 16 about a second axis of rotation 25 substantially perpendicular to the first axis of rotation 22. According to the invention, the ring 16 is connected to the main structure

Advantageously, the gyroscopic actuator 10 comprises at least one suspension element 13 able to limit microvibrations emanating from the rotation of the cradle 18 and of the flywheel 21.

Advantageously, the gyroscopic actuator 10 according to the invention may further comprise at least one end-stop element 14 able to limit a travel of the cradle 18 and of the flywheel 21 with respect to the main structure 11.

In this application, in so far as the ring 16 is concerned, we shall speak only of a ring in order to facilitate understanding, but the term ring is to be understood in the broadest sense. The ring is to be understood as being a volume with an opening at its centre. It may be a solid of revolution such as a torus or any other polyhedron with an opening at its centre, namely a polyhedron the cross section of which may adopt diverse shapes. The ring may also be a holed polygon. The ring 16 is holed in such a way that the flywheel 21 is placed in the hole, the midplane of the ring 16 not necessarily coinciding with that of the flywheel 21.

In this application, the ring 16 is depicted as being in a single piece. It would of course not constitute a departure from the scope of the invention to consider a ring made up of several sub-parts joined together by known fixing means. The same is true of the cradle 18 and of the main structure 11.

The cradle 18 and the flywheel 21 form a subassembly referred to as the gimbal subassembly 17. And the ring 16 and the gimbal subassembly 17 form the suspended assembly 15.

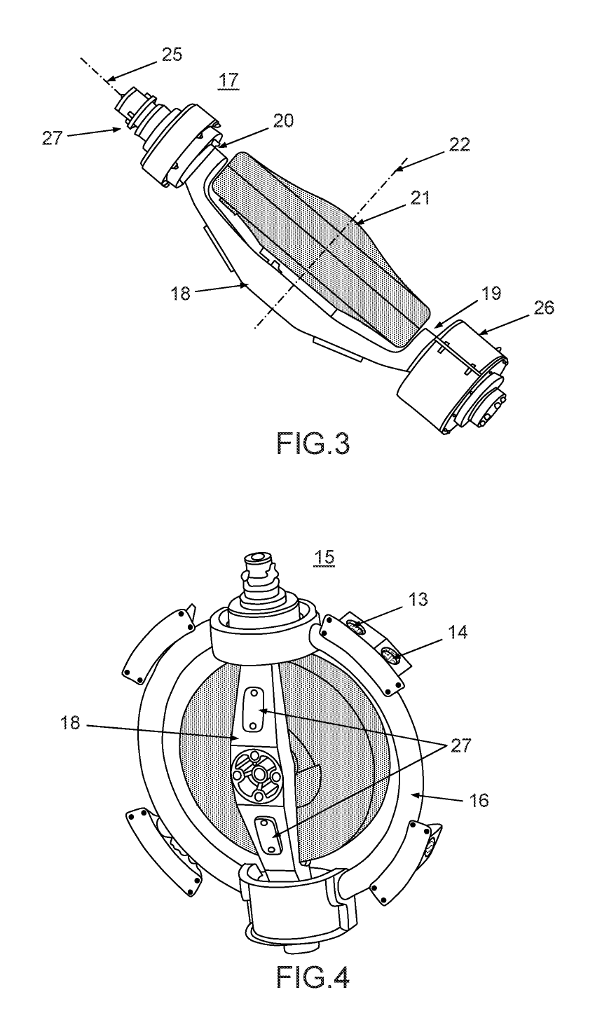

FIG. 3 depicts the gimbal subassembly 17 of the dual guidance gyroscopic actuator 10 according to the invention. As described previously, the gimbal subassembly 17 is made up of the flywheel 21 mounted on the cradle 18, the cradle 18 is guided by two bearings 23, 24, also referred to as guide elements, at these two ends 19, 20. The bearings 23, 24 may be any suitable type of bearing. Mention may for example be made of plain bearings or preferably of rolling bearings, such as, for example, ball bearings or roller bearings. According to the invention, the gimbal subassembly 17 may comprise a motorization 26 in the first 19 of the two ends of the cradle 18, which motorization is intended to drive the cradle 18 in rotation about the second axis of rotation 25. The gimbal subassembly 17 may comprise a power- and signal-transfer element 27 in the second 20 of the two ends of the cradle 18 and which is intended to transfer power and signals between the flywheel 21 and the platform. The signals emanating from the flywheel 21 may, for example, be temperature, speed, position signals originating from various sensors present in the flywheel 21. The transfer of signals may also be from the platform to the flywheel, notably in the case of the power supply to the flywheel. The power- and signal-transfer element 27 may be a slip ring involving contact or a contactless transformer. Advantageously, a contactless transformer will be preferred over a slip ring that involves contact because such a component markedly improves the stresses associated with lifespan. This is because a slip ring involving contact works by the rubbing-together of the brushes and tracks in order to transfer power and signals. The rubbing limits the life of the slip ring and disturbs the control of the satellite as the direction of rotation of the gimbal changes.

The gyroscopic actuator 10 may also comprise a position or speed sensor, for example in the first end 19 of the cradle 18. The sensor may be an optical encoder that allows servocontrol of the position and rotational speed of the gimbal subassembly 17.

The second axis of rotation 25, which means to say the axis of rotation of the gimbal, may be inclined at a certain angle with respect to the plane of interface between the main structure 11 and the platform 12, depending on the application.

The motorization part is generally made up of a motor, a position and/or speed sensor and a main rolling bearing.

The ring 16 is a complex component the role of which is to provide the suspended assembly 15 with the requisite rigidity while at the same time interfacing with the gimbal subassembly 17 and the suspension 13 and end-stop 14 elements. As indicated previously, the ring 16 may adopt various shapes and is not necessarily circular, potentially having a cross section of various possible shapes. This component can be created by additive manufacturing from an optimized organic shape.

The cradle 18 may be produced by additive manufacturing from an optimized organic shape.

The gimbal subassembly 17 is guided with respect to a ring-shaped structure 16. This assembly referred to as the suspended assembly 15 is suspended by the suspension element or elements 13.

FIG. 4 depicts the suspended assembly 15 of the dual guidance gyroscopic actuator 10 according to the invention. The gimbal subassembly 17, namely the ring 16, the cradle 18 and the flywheel 21, has a centre of gravity Gc. The gimbal subassembly 17 is configured to have its centre of gravity on the second axis of rotation 25. This configuration can be obtained by construction, with a particular shape of cradle 18 and/or of flywheel 21 and by virtue of the relative positioning of one with respect to the other.

In order to have its centre of gravity on the second axis of rotation 25, the gimbal subassembly 17 may comprise at least one bob weight 27, so as to position the centre of gravity Gc of the gimbal subassembly 17 on the second axis of rotation 25. The part rotating about the second axis of rotation 25, or gimbal axis, which part is essentially made up of the flywheel 21 and of the cradle 18 is rotationally balanced by positioning its centre of gravity Gc on the axis of rotation 25. One or more balance weights, also referred to as bob weights 27, are provided on the cradle 18 in order to adjust the position of the centre of gravity Gc of the mobile part, namely of the gimbal subassembly 17, on the axis of rotation 25. The number, the positioning, the shape of the balance weights 27 may vary according to the configuration considered. In FIG. 4, they are positioned on one face of the cradle 18 but could equally well be positioned on another face of the cradle 18 or on the flywheel 21. Positioning the centre of gravity Gc of the gimbal subassembly 17 on the axis of rotation 25 makes it possible to prevent the flywheel 21 from rotating during launch and to limit the microvibrations generated by the rotation of the gimbal subassembly 17. If these microvibrations are not limited, performance is then impaired.

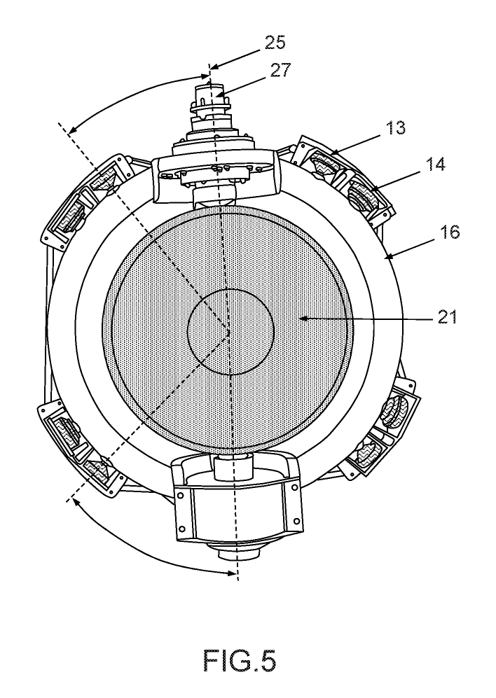

FIG. 5 depicts one example of a configuration of the suspension elements 13 and end-stop elements 14 of the dual guidance gyroscopic actuator 10 according to the invention. This example gives a configuration involving four suspension elements 13 and four end-stop elements 14 the axes of which are positioned in the same plane, the axes pointing towards the centre of gravity Gs of the suspended assembly 15.

The invention relies on the use of the suspension 13 and end-stop elements 14 to perform a function of filtering the microvibrations generated by the rotation of the flywheel 21 and by the motorization of the gimbal during phases of manoeuvring and image taking of the satellite by means of the suspension elements 13 and to perform a launch load absorbing function by virtue of the end-stop elements 14.

The number of these elements 13, 14 may be multiplied around the mobile payload according to the mobile mass and filtration performance to be achieved, in order to meet the desired goals. In FIG. 5, the number of suspension elements 13 is equal to the number of end-stop elements 14, but such is not necessarily the case. The number of suspension elements 13 may differ from the number of end-stop elements 14.

The suspension elements 13 and the end-stop elements 14 are mounted between the assembly that is to be isolated and that generates the microvibrations exported and the main structure 11 connected to the platform. It may be noted that the suspension elements 13 and the end-stop elements 14 of the invention can be dimensioned specifically according to the use made of them, but it is also possible to emphasize that they may be standard suspension and end-stop elements requiring no redesign of the gyroscopic actuator whatsoever. Specifically, the module nature of these suspension elements 13 and end-stop elements 14 means that the number of elements can be chosen and these elements laid out according to the performance to be achieved, according to the suspended mobile mass and according to the launch loadings.

In this application, a distinction will be made between a suspension element 13 and an end-stop element 14. Nevertheless, the invention applies similarly to an element in common which is both a suspension and an end-stop element. In other words, it is possible to apply the invention using an element that has both the role of a suspension element and that of an end-stop element.

The suspension element 13 and the end-stop element 14 are used to complement one another: specifically, during the launch, the end-stop element 14 performs the retention function. The movement of the mobile payload is limited and damped. In other words, the movement of the mobile payload is controlled. During image-taking the suspension elements 13 filter out the microvibrations generated by the suspended assembly 15 without any contact at the end-stop element 14. The stiffness of the suspension elements 13 is weaker than the stiffness of the end-stop elements 14, typically by a factor of 10. On launch, the suspension element 13 follows the deformation of the end-stop element 14.

More specifically, a three-dimensional clearance is created around the end-stop element 14. The suspension element 13 works and filters out microvibrations. The combined rotations of the flywheel 21 and of the cradle 18 generate a gyroscopic torque that is to be transmitted to the platform. When the gryoscopic torque is generated, the suspension element 13 is deformed until the end-stop element 14 takes over. The end-stop element 14 deforms until the clearance has all been taken up and there is contact with the end-stop element 14. The gyroscopic torque is then transmitted to the platform essentially by the end-stop element 14.

The suspension elements 13 may be placed in the same plane, the barycentre of all of these elements advantageously being coincident, or substantially coincident, with the centre of gravity of the suspended assembly 15. The axes of these elements may be positioned in the same plane or not in the same plane. Advantageously, the choice may be made to position the axes of these suspension elements 13 equal distances away from the centre of gravity of the suspended assembly 15 and pointing, or not, towards the centre of gravity of the suspended assembly 15.

The end-stop elements 14 may also be positioned in the same plane, the barycentre of all of these elements advantageously being coincident, or substantially coincident, with the centre of gravity of the suspended assembly 15. The axes of these elements may be placed in the same plane or not in the same plane, and pointing, or not, towards the centre of gravity of the suspended assembly 15.

The planes containing the axes of the suspension elements 13 and of the end-stop elements 14 may or may not be coincident. For example, the choice may be made to place the axes of the suspension elements 13 and of the end-stop elements 14 in one and the same plane and for this plane to contain the centre of gravity of the suspended assembly 15.

The suspension elements 13 and the end-stop elements 14 may also be arranged according to the requirements at different angles in order to position the barycentre of the suspension elements 13 and/or of the end-stop elements 14 at the centre of gravity of the suspended assembly 15.

The stiffness of the suspension element 13 is lower than the stiffness of the end-stop element 14, the objective being for the stiffness of the end-stop element 14 to provide all the mechanical integrity of the mobile part during launch. In image-capturing mode, the suspension element 13 filters out the microvibrations generated by the rotation of the flywheel 21 and the rotation of the cradle 18, the end-stop element 14 not being loaded: a functional clearance is present all around the end stop.

In general, with the flywheel 21 and the cradle 18 constituting two components of a first unit, the suspended assembly 15 and the main structure 11 constituting two components of a second unit, the gyroscopic actuator 10 and the platform constituting two components of a third unit, it may be said that the at least one suspension element 13 is positioned between the two components of a unit. Likewise, the at least one end-stop element 14 is positioned between the two components of a unit. It may therefore be noted that the suspension elements 13 and the end-stop elements 14 are completely modular both in terms of the number of each of the elements and in terms of where these elements are positioned. In other words, it is possible to position the suspension element or elements 13 and/or the end-stop element or elements 14 between the flywheel 21 and the cradle 18 and/or between the suspension assembly 15 and the main structure 11 and/or between the gyroscopic actuator 10 and the platform 12. For each of the configurations (between the flywheel 21 and the cradle 18, between the suspended assembly 15 and the main structure 11, between the gyroscopic actuator 10 and the platform 12), the suspension elements 13 and/or end-stop elements 14 may be distributed uniformly or non-uniformly between the two components of the corresponding unit and the orientation of the suspension elements 13 may be the same for all the suspension elements, but may equally differ. The same is true of the end-stop elements 14. In addition, the suspension elements 13 may be oriented in the same way as the end-stop elements 14 but may also be oriented differently. These elements are completely modular.

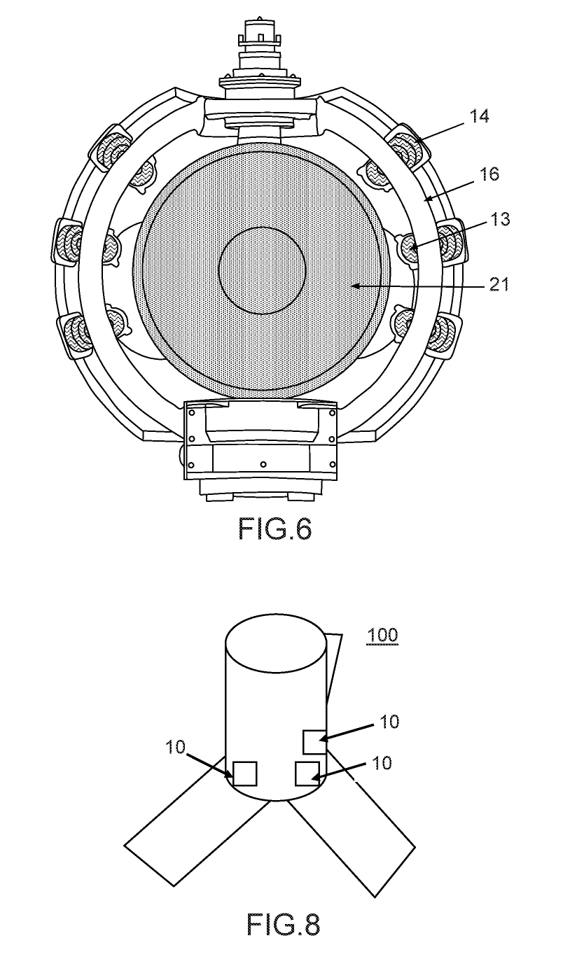

FIG. 6 depicts another example of a configuration of the suspension elements 13 and of the end-stop elements 14 of the dual guidance gyroscopic actuator 10 according to the invention.

The suspension 13 and end-stop 14 elements may be distributed as desired both in terms of the number of them and in terms of their position on the ring 16.

The suspended assembly 15 has a centre of gravity Gs, the at least one suspension element 13 has a barycentre. Further, the at least one suspension element 13 is configured in such a way that the barycentre of the at least one suspension element 13 substantially coincides with the centre of gravity Gs of the suspended assembly 15. Likewise, the at least one end-stop element 14 has a barycentre. The at least one end-stop element 14 is configured in such a way that the barycentre of the at least one end-stop element 14 substantially coincides with the centre of gravity Gs of the suspended assembly 15.

One preferred solution is to position the barycentre of all of the elements 13, 14 so that it coincides with the centre of gravity Gs of the suspended assembly 15.

These suspension 13 and end-stop 14 elements may be distributed uniformly or nonuniformly around the mobile assembly.

The planes containing the suspension elements 13 and the end-stop elements 14 may or may not be coincident.

The suspension 13 and end-stop 14 elements also make it possible to limit the load experienced by the equipment mounted on the suspended assembly 15. For example, the level of shock injected into the base of the CMG, namely between the main structure 11 and the platform 12, is filtered by the suspension 13 and end-stop 14 elements. This solution means that elements sensitive to shocks can be installed on the suspended assembly 15, notably the optical encoder and the flywheel 21.

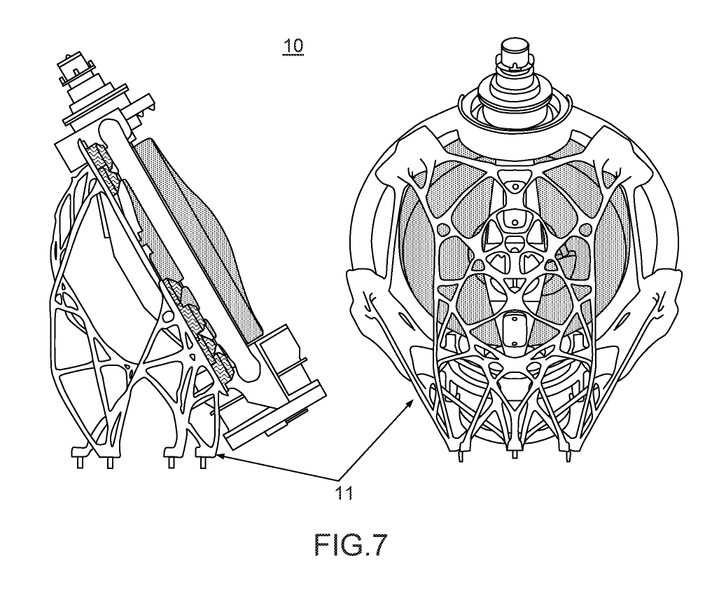

FIG. 7 depicts an embodiment of the main structure 11 of the dual guidance gyroscopic actuator 10 according to the invention. The main structure 11 supporting the suspended assembly 15 may be produced by additive manufacturing from an optimized organic shape. This possibility makes it possible to obtain a main structure 11 with the desired shape, stiffness and integrity at a considerable mass saving as compared with a traditional main structure as depicted in FIG. 2. For example, such a main structure as depicted in FIG. 2 weighs 9 kg whereas the main structure depicted in FIG. 7 weighs only 3 kg. Because the main structure 11 can adopt any desired shape, it is possible to choose the angle of inclination of the second axis of rotation 25. In FIG. 2, this angle is approximately 30°, but the possibility of adapting the main structure 11 in terms of its shape means that any angle of inclination could be had.

Thus, the invention proposes a gyroscopic actuator solution involving two modes of guidance and a motorization that is smaller, incorporating suspensions into the actuator as close as possible to the components that generate the microvibrations and by producing a gimbal assembly which is fully suspended.

The ring means that a lot of space can be made available in which to house the suspension and end-stop elements.

The advantages of this solution are a reduction in the microvibrations transmitted to the platform, with the possibility of installing a suspension system, if necessary, the limited rubbing by virtue of the use of a contactless transformer to cause power and signals to pass to and from the flywheel, thereby encouraging durability and increasing gyroscopic actuator performance because there is no dry friction torque coming from the slip ring. Another major advantage is the modularity of the suspension elements and end-stop elements. The number of elements can be multiplied and it is possible to configure them to suit the requirement according to the need for filtration, according to the suspended mass, according to the position of the centre of gravity. One major advantage is the filtration of the microvibrations generated at source in order to avoid the effect of these microvibrations becoming amplified. In addition, the end-stop elements make it possible to dispense with the need for a costly stacking system. According to the invention, the mobile payload is not stacked by virtue of the use of end-stop elements. Finally, on-board equipment is protected by limiting the loads on launch through the end-stop elements.

The invention also relates to a satellite comprising at least three gyroscopic actuators as described hereinabove and configured to manage the orientation of the satellite. FIG. 8 schematically depicts a satellite 100 comprising at least three gyroscopic actuators 10 according to the invention. Advantageously, the satellite 100 may comprise four (or more) gyroscopic actuators in order to ensure redundancy in the event of one of the gyroscopic actuators developing a fault.

1. A dual guidance gyroscopic actuator intended to be fitted to a satellite, comprising:
a main structure connected to a platform, the said platform being intended to be connected to the satellite,
a ring,
a U-shaped cradle, having a first end and a second end and a central part,
a flywheel mounted on the central part of the cradle between the first and second ends, the flywheel being rotationally mobile with respect to the cradle about a first axis of rotation,
comprising a first bearing positioned at the first end of the cradle and a second bearing positioned at the second end of the cradle connecting the ring to the cradle, the first and second bearings being configured to render the cradle rotationally mobile with respect to the ring about a second axis of rotation substantially perpendicular to the first axis of rotation, and wherein the ring is connected to the main structure.

2. The gyroscopic actuator according to the claim 1, comprising at least one suspension element able to limit microvibrations emanating from the cradle and from the flywheel.

3. The gyroscopic actuator according to claim 1, further comprising at least one end-stop element able to limit a travel of the cradle and of the flywheel with respect to the main structure.

4. The gyroscopic actuator according to claim 1, comprising a motorization in the first end of the cradle, which motorization is intended to drive the cradle in rotation about the second axis of rotation.

5. The gyroscopic actuator according to claim 1, comprising a power- and signal-transfer element in the second end of the cradle, which element is intended to transfer power and signals between the flywheel and the platform.

6. The gyroscopic actuator according to claim 1, the cradle and the flywheel forming a subassembly having a centre of gravity, wherein the subassembly is configured to have its centre of gravity on the second axis of rotation.

7. The gyroscopic actuator according to claim 2, the ring, the cradle and the flywheel forming a suspended assembly, the flywheel and the cradle constituting two components of a first unit, the suspended assembly and the main structure constituting two components of a second unit, the gyroscopic actuator and the platform constituting two components of a third unit, wherein the at least one suspension element is positioned between the two components of a unit.

8. The gyroscopic actuator according to claim 3, the ring, the cradle and the flywheel forming a suspended assembly, the flywheel and the cradle constituting two components of a first unit, the suspended assembly and the main structure constituting two components of a second unit, the gyroscopic actuator and the platform constituting two components of a third unit, wherein the at least one end-stop element is positioned between the two components of a unit.

9. The gyroscopic actuator according to claim 2, the ring , the cradle and the flywheel forming a suspended assembly having a centre of gravity, the at least one suspension element having a barycentre, wherein the at least one suspension element is configured in such a way that the barycentre of the at least one suspension element coincides substantially with the centre of gravity of the suspended assembly.

10. The gyroscopic actuator according to claim 3, the ring, the cradle and the flywheel forming a suspended assembly having a centre of gravity, the at least one end-stop element having a barycentre, wherein the at least one end-stop element is configured in such a way that the barycentre of the at least one end-stop element coincides substantially with the centre of gravity of the suspended assembly.

11. A satellite, comprising at least three gyroscopic actuators according to claim 1, configured to manage the orientation of the satellite.
